(19) United States
(12) Patent Application Publication
(10) Pub. No.: US 2003/0035711 A1
(43) Pub. Date: Feb. 20, 2003

(54) Centering double side edge grip end effector with integrated mapping sensor

(76) Inventor: Ulysses Gilchrist, Reading, MA (US)

Correspondence Address: PERMAN & GREEN, 425 POST ROAD, FAIRFIELD, CT, 06824, US

(21) Appl. No.: 10/196,679

(22) Filed: Jul. 15, 2002

Related U.S. Application Data
(60) Provisional application No. 60/305,384, filed on Jul. 14, 2001.

(51) Int. Cl. B25J 15/08

(52) U.S. Cl. 414/744.5; 414/744.8; 414/941

(57) ABSTRACT

A substrate transport apparatus comprising a drive section, an articulated arm, and a gripper. The articulated arm is connected to the drive section. The articulated arm has an end effector for transporting a substrate. The gripper is connected to the end effector for holding the substrate on the end effector. The gripper has at least two actuated contact pads for gripping the substrate. The two actuated contact pads are disposed on the end effector so that when actuated the contact pads are translated inwards relative to the end effector to grip the substrate and position a center of the substrate to a predetermined location on the end effector irrespective of a dimensional variance of the substrate.

### CROSS-REFERENCE TO RELATED APPLICATION(S)

This application claims the benefit of U.S. Provisional Application No. 60/305,384, filed Jul. 14, 2001, which is incorporated by reference herein in its entirety.

### BACKGROUND OF THE INVENTION

1. Field of the Invention

The present invention relates to a substrate transport apparatus and, more particularly, to a substrate transport apparatus having an edge grip end effector.

2. Prior Art

Substrate transport apparatus, such as used in the transport of semi-conductor wafers or flat panel displays, generally have an end effector for holding the substrate during movement of the transport apparatus. There are examples of end effectors that use a vacuum chuck to hold the substrates on the end effector. This may result in contamination of one side of the substrate which comes into contact with the end effector. There are other examples of end effectors which use edge gripping to hold the substrate on the end effectors. U.S. Pat. No. 5,988,971 discloses one example of a wafer transfer robot that comprises a wafer paddle for carrying a wafer. The wafer paddle has edge grippers that releasably grip the wafer by its edges. The edge grippers include stationary edge grippers and a movable edge gripper which is moved against the wafer so that it is gripped between the stationary and movable edge grippers. Another example of a slice handling apparatus is disclosed in U.S. Pat. No. 5,022,695. This apparatus has a center tine and two side tines. The side tines are fixed in position while the center tine is moved in and out. The tines have locator pins which hold the slice. The locator pin on the movable tine urges the slice against the locator pins on the fixed tines to grip the slice. Still another example of an apparatus for transporting wafers is disclosed in U.S. Pat. No. 6,092,971 wherein the apparatus has a gripping device with a fixed holding rake and several gripping heads which can be rotated with respect to the holding rake.

As can be realized from the aforementioned examples, substrate transport apparatus with this type of edge grip end effectors have a grip that generally biases the substrate to one side. That is, the edge grips push the wafer from one side against fixed hard stops. This does not truly reference the substrate center, but rather the reference here is in fact the substrate edge. Accordingly, the centering accuracy of these end effectors is impacted by the variance in the substrate diameter due to substrate diameter tolerances. This style of edge grip end effectors have a lower throughput than vacuum grip end effectors due to an extra motion used with these end effectors in order to pick and place substrates with minimal substrate sliding on the supports. The extra motion also avoids pushing the substrate into rear substrate supports. The present invention provides an edge grip end effector with self centering features, that has the throughput comparable to vacuum grip effectors without the contamination concerns associated with vacuum grip effectors.

### SUMMARY OF THE INVENTION

In accordance with a first embodiment of the present invention, a substrate transport apparatus is provided. The apparatus comprises a drive section, an articulated arm, and a gripper. The articulated arm is connected to the drive section. The articulated arm has an end effector for transporting the substrate. The gripper is connected to the end effector for holding the substrate on the end effector. The gripper has at least two actuated contact pads for gripping the substrate. The two actuated contact pads are disposed on the end effector so that when actuated the two contact pads are translated inwards relative to the end effector to grip the substrate and position a center of the substrate to a predetermined location on the end effector irrespective of a dimensional variance of the substrate.

In accordance with another embodiment of the present invention, a substrate transport apparatus is provided. The apparatus comprises a drive section, an articulated arm, and a gripper. The articulated arm is connected to the drive section for transporting a substrate. The articulated arm has an end effector for holding the substrate. The end effector has a substrate support section with support pads for supporting the substrate. The support pads project from a surface of the support section so that when the substrate is seated on the end effector the support pads support the substrate elevated from the surface of the support section. The gripper is mounted on the end effector for securing the substrate to the end effector. The gripper has contact pads disposed on the end effector for gripping a peripheral edge of the substrate and stably holding the substrate in the gripper. All contact pads of the gripper are actuated to move relative to the end effector between a first position and the second position.

In accordance with another embodiment of the present invention, a substrate transport apparatus is provided. The substrate transport apparatus has an articulated arm with an end effector for holding a substrate, and a gripper on the end effector for capturing the substrate to the end effector. The gripper has a pair of movable arms extending on opposite sides of the end effector for gripping the substrate. Each arm is movably connected to the end effector to move relative to the end effector. The gripper has an actuator connected to the movable arms for moving the arms in opposite directions relative to each other between open positions and closed positions.

In accordance with a method of the present invention, a method for transporting a substrate with a substrate transport apparatus is provided. The method comprises the steps of providing the substrate transport apparatus with an end effector for carrying the substrate, picking the substrate with the end effector, actuating contact pads, and moving the end effector. The substrate transport apparatus is provided with a gripper for holding the substrate on the end effector. The gripper has actuated contact pads for gripping the substrate.

The substrate is picked with the end effector. The contact pads are actuated so that the gripper closes and secures the substrate to the end effector substantially simultaneously with picking the substrate. The end effector is moved to a predetermined position.

### BRIEF DESCRIPTION OF THE DRAWINGS

The foregoing aspects and other features of the present invention are explained in the following description, taken in connection with the accompanying drawings, wherein:

FIG. 1 shows a perspective view of a substrate transport apparatus incorporating features of the present invention;

FIG. 2 is a top plan view of an end effector of the substrate transport apparatus in FIG. 1, and a substrate S;

FIG. 2A is a partial elevation view of the end effector taken along line 2A-2A in FIG. 2;

FIG. 3 is another top plan view of the end effector in FIG. 2 showing the end effector in a second position; and

FIG. 4 is a schematic top plan view of the end effector in FIG. 2 showing the linkage of the end effector in two positions corresponding to the positions of the end effector in FIGS. 2-3, and

FIG. 5 is a top plan view of an end effector in accordance with another embodiment of the present invention.

### DETAILED DESCRIPTION OF THE PREFERRED EMBODIMENT

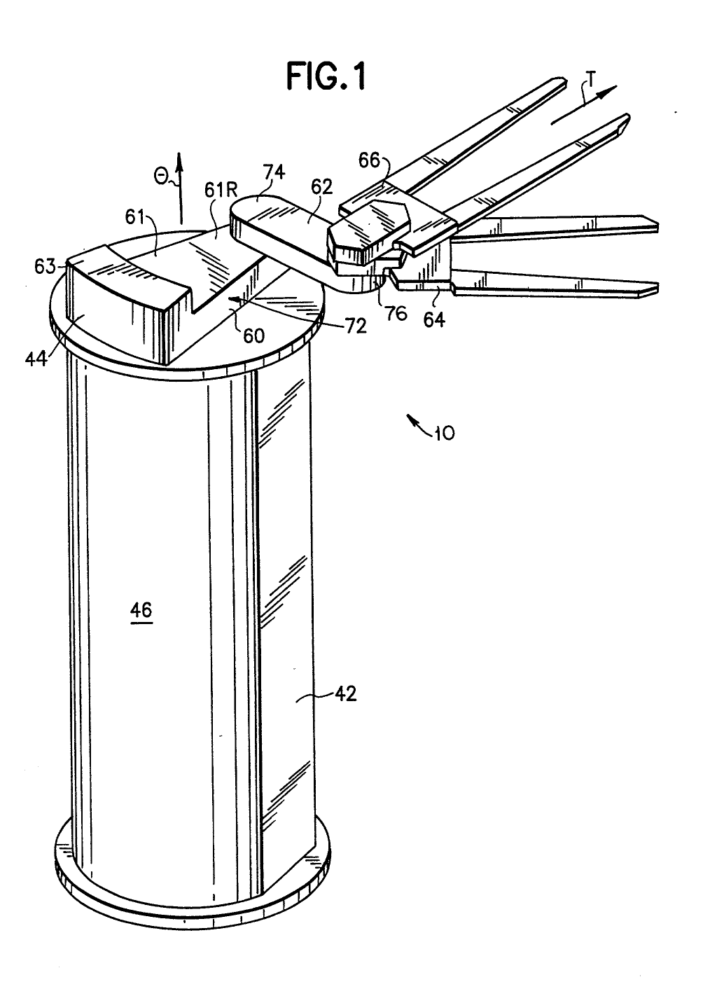

Referring to FIG. 1, there is shown an exploded perspective view of a substrate transport apparatus 10 incorporating features of the present invention. Although the present invention will be described with reference to the single embodiment shown in the drawings, it should be understood that the present invention can be embodied in many alternate forms of embodiments. In addition, any suitable size, shape or type of elements or materials could be used.

In this embodiment, the substrate transport apparatus generally comprises a drive unit 42 and articulated arm assembly 44. The arm assembly 44 is mounted on the drive unit 42. As seen in FIG. 1, the arm assembly 44 includes an upper arm 60, a forearm 62 and an end effector 64. The arm assembly 44 shown in FIG. 1 has an exemplary configuration, and the instant invention is equally applicable to any other suitable kind of arm assembly such as for example an arm assembly with a frog leg arm linkage configuration. The upper arm 60, forearm 62, and end effector 64 are connected in series. The upper arm 60 is pivotally joined to the forearm 62 at the elbow 74. The forearm 62 is pivotally joined to the end effector 64 at the wrist 76. In the embodiment shown in FIG. 1, the arm assembly 44 has a second end effector 66 pivotally supported from the forearm 62. Although, the present invention will be described below with reference to the substrate transport apparatus 10 shown in FIG. 1, the present invention is equally applicable to any other substrate transport apparatus.

Still referring to FIG. 1, the drive unit 42 may have a housing or casing 46 which houses the drives of the drive unit. The drive unit 42 may be a three-axis drive capable of moving the articulated arm 44 along three axes. For example, the drive unit may have a suitable drive for vertically raising and lowering the arm 44. The drive unit 42 may further include a co-axial drive for rotating the arm about rotation axis θ (i.e. θ movement) and for extending and retracting the arm along the radial axis T (i.e. T movement) as shown in FIG. 1. The co-axial drive of drive unit 42 may be substantially the same as the co-axial drive shown in U.S. Pat. No. 5,899,658 which is incorporated by reference herein in its entirety. The co-axial drives of the drive unit 42 may be connected using suitable linkages or transmission systems to rotate the end effectors 64, 66 on the arm. The linkages may be arranged so that the end effectors may be rotated independent of each other and of the rest of the arm, or the end effectors may be coupled to move in unison with the arm.

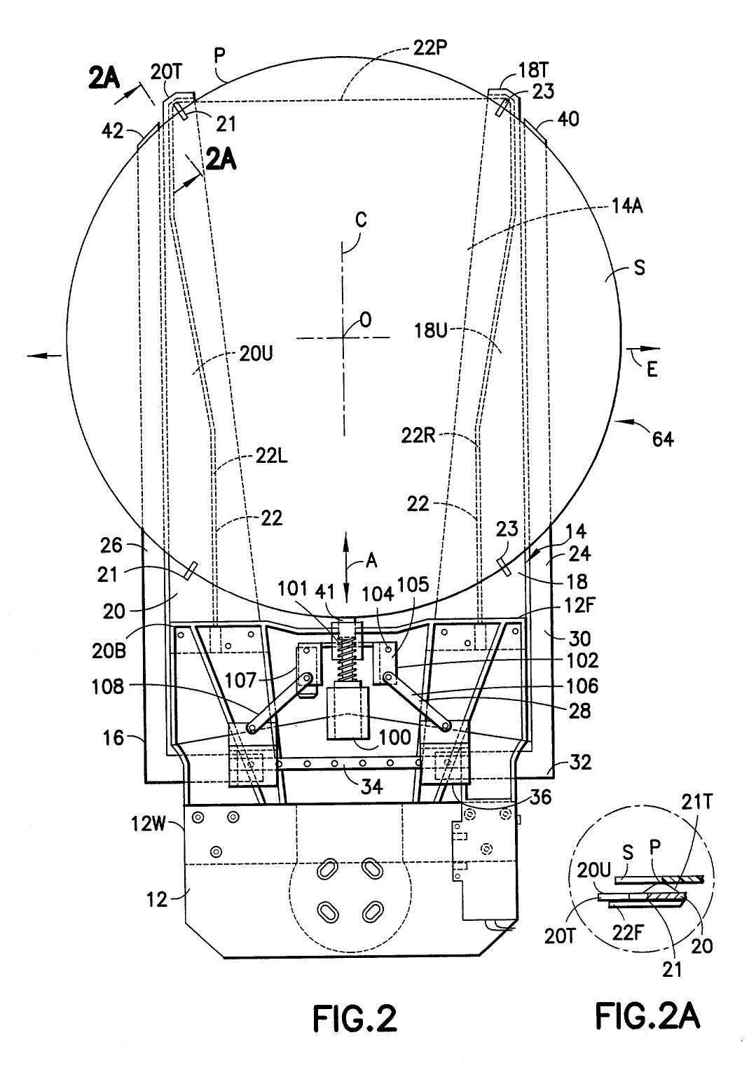

Referring now to FIG. 2, there is shown a plan view of one end effector 64 and a substrate S supported by the end effector. Substrate S may be a 200/300 mm wafer or may be a flat panel display. The end effector 64 generally comprises a base section 12, a support section 14, and a grip section 16. The support and grip sections 14, 16 depend from the base section 12. The base section 12 generally comprises a block of any suitable shape (e.g. generally hexahedron) or plate with a suitable interface to allow mounting of a pivot shaft (not shown) to the end effector. As can be realized from FIG. 1, the shaft attached to the base section 12 of the end effector 64 may be pivotally mounted to the forearm 62 to allow free rotation of the end effector about the wrist 74 relative to the forearm. Suitable bearings such as for example needle bearings may be used to support the end effector shaft in the forearm.

As seen in FIG. 2, the support section 14 in this embodiment has two tines or fingers 18, 20 that cantilever outwards from the base section 12 of the end effector. The tines 18, 20 extend longitudinally forwards from the base section sufficiently to provide a support area 14A that holds the substrate on the end effector 64. The substrate support area 14A has an axis of symmetry C and a center O as shown in FIG. 2. The center O of the support area 14A may be used as a reference datum for establishing the motion profile of the arm assembly, such as for example when moving the arm assembly in a substrate processing apparatus (not shown). In alternate embodiments, the end effector support section may have any other suitable shape to provide a sufficient support area for holding the substrate. For example, the support section may include any number of tines, or may be a single plate as desired. Tines 18, 20 are substantially similar to each other but opposite hand. In this embodiment, each tine 18, 20 has a generally tapered shape that widens from the tip 18T, 20T to the base 18B, 20B of the tine. Each tine 18, 20 is a substantially flat member made from any suitable material such as plastic or metal. The tines are cantilevered from the front end 12F of the base section 12. The tines may be fastened by any suitable means to the base section, such as for example mechanical fasteners, or brazing. In alternate embodiments, the base section and support section of the end effector may be formed as a one piece member. The tines 18, 20 are disposed sufficiently apart to provide the substrate support area 14A with sufficient size laterally for holding substrate S thereon. The tines 18, 20 may have a substantially flat upper surface 18U, 20U with a suitable coating for holding the substrate S thereon. In the embodiment shown in FIG. 2, the upper surface 18U, 20U of each tine 18, 20 may have two seats 21, 23 projecting from the upper surface upon which the substrate is seated to maintain the substrate elevated and minimize the contact areas between the tines and the substrate S.

Referring also to FIG. 2A, there is shown a partial elevation view of the end effector 64 taken along view line 2A-2A in FIG. 2. In this embodiment, the end effector has four seats 21, 23, with two seats on each tine 18, 20, as noted before. In alternate embodiments, the end effector may have any suitable number of seats to provide a substantially equally support distribution around the substrate seated on the end effector. The seats 21, 23 are substantially the same in this embodiment and will be described below with respect to a representative seat 21 shown in FIG. 2. The seat 21 is shown in FIG. 2 as having an exemplary profile with sloped sides and a top contact surface 21T which contacts the substrate S when landed on the end effector. The contact surface 21T may be substantially flat and small to minimize the contact area on the substrate S. In alternate embodiments, the seats may have any other desired shape. As seen in FIG. 2, the two seats 21, 23 on the upper surface of each tine 18, 20 are located at a distance from the center of the support area 14A so that when the substrate S is landed on the seats 21, 23, the seats contact the substrate only at its outer edge P.

The end effector 64 may have one or more sensors for detecting features of the substrate in order to facilitate moving the end effector to a remote substrate, placing of the substrate on the end effector, as well as mapping a substrate storage container or loadport to identify substrate locations therein. As seen in FIG. 2, in this embodiment the end effector 64 has a sensor 22 capable of detecting a peripheral edge P of the substrate S and if desired a bottom surface of the substrate. In alternate embodiments, the end effector may have any other suitable substrate detection sensors mounted thereon. In this embodiment, the sensor 22 is an optical sensor. The sensor 22 includes optical fibers 22L, 22R which extend under the tines 18, 20 as shown in FIG. 2. One optical fiber 22L, 22R may be a light source fiber connected to a suitable light source (e.g. laser) which is not shown. The other fiber 22L, 22R may be a light receiving fiber connected to a suitable light sensor such as a photo cell (not shown). The light source and light sensor may be mounted to the base section 12 of the end effector to reduce that mass moment of inertia of the end effector and thereby improve rotational control of the end effector about the wrist 76 (See FIG. 1). As seen in FIG. 2, the fibers 22L, 22R are bent towards each other proximate the tips 18T, 20T of the tines 18, 20 so that the light emitting aperture at the end of the light source fiber is facing the light receiving aperture in the end of the light receiving fiber. The facing apertures in the optical fibers 22L, 22R thus form a light pathway 22P between the ends of the fibers. When the pathway 22P is broken such as by the bottom surface of the substrates or the peripheral edge of the substrate, the break is detected by the light sensor and a suitable indication signal is transmitted to a controller (not shown) to register the detection of the substrate feature.

Still referring to FIG. 2, the grip section or gripper 16 preferably includes a pair of opposing gripping tines or fingers 24, 26 and actuating mechanism 28. The actuating mechanism 28 operates the gripping tines 24, 26 to grip and release the substrate S carried by the end effector as will be described in greater detail below. The gripping tines 24, 26 are substantially similar to each other but opposite hand. Accordingly, the description below will be with particular reference to gripping tine 24. The gripping tine 24 includes a transverse member 32, and an elongated longitudinal member 30. The longitudinal member 30 depends from the transverse member 32. As shown in FIG. 2, the gripping tine is located adjacent to a corresponding support tine 18, with the longitudinal member 30 extending substantially alongside the support tine and the transverse member 32 extending transverse to the support tine. The grip tine 24 may be foundationed from the support tine 18, or may be otherwise supported from the base section of the end effector as shown in FIG. 2. In this embodiment, a linear bearing 34 is mounted to the underside of the base section 12. As seen in FIG. 2, the linear bearing 34 is located proximate the wrist end 12W of the base section and away from the substrate support area 14A. This has the advantage of minimizing possible contamination of the substrate in the support area 14A from any particulate matter generated from the operation of the linear bearing. The linear bearing may be made from any suitable bar material, and may have a suitable number of bearings mounted on the exterior of the bar. In alternate embodiments, the linear bearing may have any other desired configuration. The transverse member 32 of the gripping tine has a bushing or socket 36 at the inner end. The socket 36 has a bore which is sized to form a close fit around the linear bearing. This will hold the socket on the linear bearing with out play while allowing the socket to slide freely, without noticeable stiction, back and forth along the linear bearing 34. The gripping tine 24 may be mounted onto the end effector by sliding the socket 36 on transverse member 32 onto one end of the linear bearing 34. The linear bearing 34 thus vertically supports gripping tine 24 while allowing the tine to move transversely (in the direction indicated by arrows E on FIG. 2) relative to the end effector center line C. The opposite gripping tine 26 is similarly mounted to the opposite end of the linear bearing, and thus is also capable of movement in and out in the direction indicted by arrows E. Each gripping tine is provided with a substrate gripping member or contact pad 40, 42. The gripping member 40, may be a tab or other such member, which projects upward from the elongated longitudinal members 24, 26. The gripping members 40, 42 may have a generally curved shape which conforms to the curvature of the outer edge P of the substrate S. In the embodiment shown in FIG. 2, the gripping members are located at the outer end of the longitudinal members 24, 26, though in alternate embodiments the gripping members may be located at any desired location along the gripping tines. The gripping members 40, 42 may be located on the gripping tines so that when the tines are in the closed position, (as shown in FIG. 2), the gripping members are in contact with the outer edge P of the substrate S held by the end effector. In this embodiment, the gripping members 40, 42 are located on the end effector so that the respective gripping members 40, 42 contact the edge P of the substrate S at approximately the two and ten o'clock positions, when the gripping tines 24, 26 are closed. In alternate embodiments, the gripping members may be located to contact the peripheral edge of the substrate on the end effector at any other desired locations. In other alternate embodiments, the gripping tines may have more than one gripping member thereon.

Actuating mechanism 28 is used to open and close the gripping tines 24, 26. Actuating mechanism 28 generally includes an actuator 100, and linkage 102 which is operably connects to the actuator to the gripping tines 24, 26. The actuator 100 may be of any suitable type such as a spring loaded solenoid or pneumatic actuator. The actuator 100 has a shaft 101 which may be moved axially back and forth (in the direction indicated by arrow A). In this embodiment, the actuator 100 is located centrally between the support tines. The actuator may be fixedly mounted from the support tines or from base section 12 of the end effector 64 as shown in FIG. 2. Linkage 102 generally includes a central bracket 104, and opposing links 106, 108 extending from opposite sides of the bracket 104. The center bracket 104 may have a cross member which is fixedly attached by any suitable means to the shaft of the actuator 100 so that the center bracket 104 moves as a unit with the actuator shaft. In this embodiment, the cross member of the center bracket 104 has a third substrate gripping member 41 (see FIG. 2) dependent therefrom. Accordingly, the bracket is positioned so that when in the closed position (shown in FIG. 2), the gripping member 41 on the bracket is in contact with the outer edge of the substrate S. The gripping member 41 is located to contact the substrate edge at substantially the twelve o'clock position. The center bracket 104 may include a pair of clevises 105, 107 located at opposite ends of the cross member. One link 106, 108 is pinned to the each clevis 105, 107 so that each link may rotate relative to the corresponding clevis 105, 107. The other end of each link is pinned to a corresponding socket 36 on the gripping tines 24, 26. Accordingly, as can be realized from FIG. 2, when the actuator 100 is energized and de-energized (i.e. the actuator shaft 101 moves back and forth in the direction indicated by arrow A), the center bracket 104 is moved back and forth in the direction of arrow A. This motion is transformed by the links 106, 108 into transverse motion which moves the gripping tines 24, 26 along the linear bearing 34 in and out with respect to the end effector centerline C in the direction indicated by arrow E. The links 106, 108 in this embodiment are of substantially equal length, and hence, the gripping tines 24, 26 are moved transverse to centerline C substantially equal amounts. In alternate embodiments, unequal length links may be used if desired to provide the gripping tines with different travel distances.

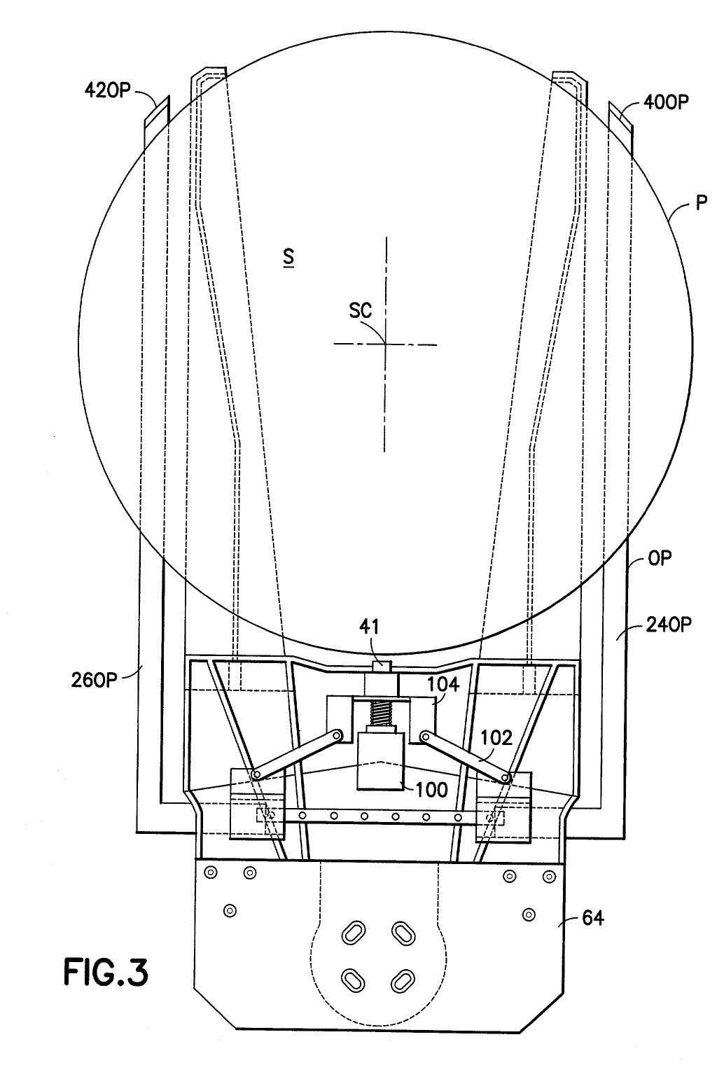

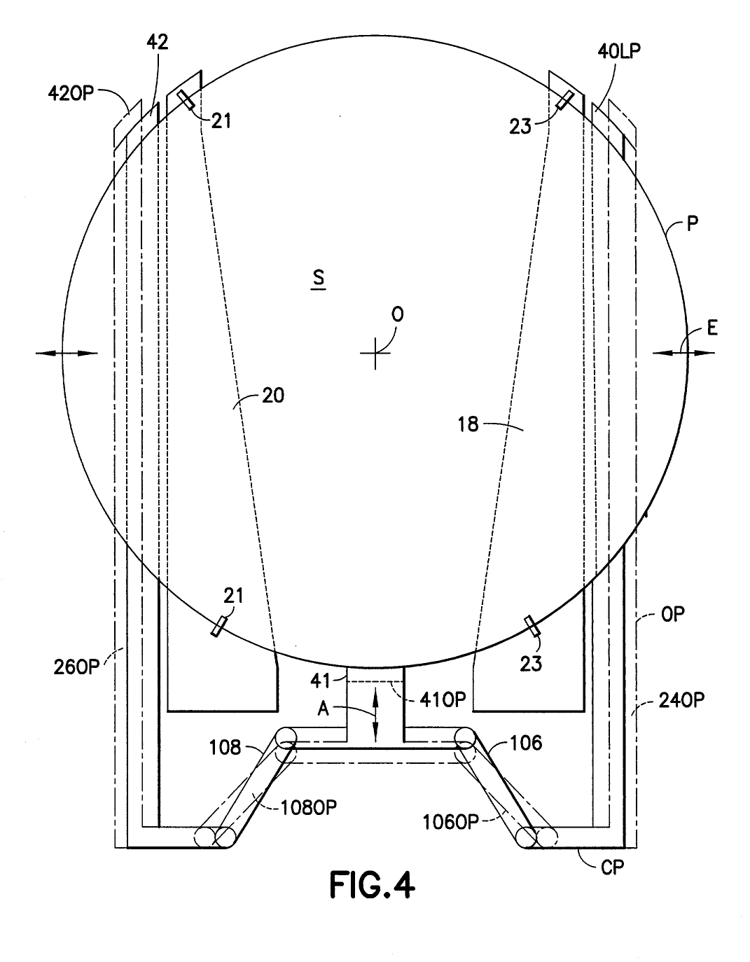

FIG. 3 is a plan view which shows the end effector 64 with the gripping tines 24OP, 26OP in the open position (suffix OP is added to the reference numbers of the end effector features shown in the open position in FIGS. 3-4). In the open position OP, the center bracket 104OP of the actuating mechanism is moved back away from the substrate S. This moves the center gripping member 41OP away from the substrate edge. The gripping tines 24OP, 26OP are also displaced outwards, away from the center O of the substrate support area 14A (see FIG. 2) of the end effector and from the support tines. With the gripping tines moved outwards, the front gripping members 40, 41 on the gripping tines are also moved away from the substrate edge P. This releases the substrate S with one quick motion from the end effector, and the end effector may move down and away from the substrate S. The gripping tines are moved laterally sufficiently to allow for clearance around the substrate S during vertical pick or release motion. To capture a substrate S, the end effector 64 is moved (vertically) under the substrate until the substrate contacts the seats of the support tines. Optical sensors may be used to sense the substrate S as previously described and hence assist seating the substrate S onto seats 21, 23 of the support tines 18, 20 (see FIG. 2). In this embodiment, the actuator 100 may be operated to move the gripping tines 24, 26 back to the closed position shown in FIG. 2 substantially at the same time as the vertical pick motion of the end effector 64 seating the substrate S on the seats 21, 23. The arrangement of the gripping members 40, 41, 42 and motion of the gripping tines 24, 26 in combination with the seat configuration in this embodiment allows the pick (i.e. substrate seating) and place (positioning of the substrate within the support area 14A) to be performed substantially simultaneously as will be described further below. The closing of the gripping tines 24, 26 is accomplished in a substantially reversed manner to the opening of the tines described above, brings the front gripping members 40, 42 and the center grip 41 (on the center bracket of the actuating mechanism) back into contact with the substrate edge.

FIG. 4 shows the positions of the gripping tines and of the actuating mechanism linkages when the gripping tines are opened (indicated at 24OP, 26OP with members 40OP, 42OP) and closed. The substantially equal and opposite action of the opposing gripping tines 24OP, 26OP as well as the center gripping member 41 on closing results in the substantial centering of the substrate S onto the substrate support area 14A of the end effector 64. Hence, the substrate center (shown at SC in FIG. 3) is maintained aligned with the center O of the substrate support area 14A during closure of the gripping tines 24, 26. As can be realized, the centering motion during closure of the gripping tines results in the alignment of the substrate center with the center O of the support area 14A being maintained for each and every substrate picked with the end effector 64 regardless of the variance in the diameter of the substrates. Placement of the substrate on the end effector is thus performed by the gripping member 40, 42 on gripping tines 24, 26 and the center gripping member 41 in one step. Moreover, the timing of the closure of the gripping tines 24, 26, and hence the placement of the substrate may occur at substantially the same time as the vertical pick which seats the substrate on the end effector. The reason fir this, as noted before, is that the support seats 21, 23 are used only for vertical support and do not affect placement of the substrate in any way. Indeed, it is desired that placement of the substrate by closing the gripping tines 24, 26 occur substantially simultaneously with seating of the substrate to ensure that the peripheral edge P of the substrate S lands on the top (for example 21T) of the seats 21, 23. In alternate embodiments however, the seating of the substrate on the seats may be performed if desired before the closure of the gripping tines. Contact between the substrate S and the end effector structure is limited to the support seats and contact with the grip members 40, 41, 42 along the outer edge. The gripping members contact the substrate edge with a predetermined force sufficient to prevent the substrate from moving during high acceleration moves. Once the substrate S is captured, the arm may be moved to transport the substrate S as desired.

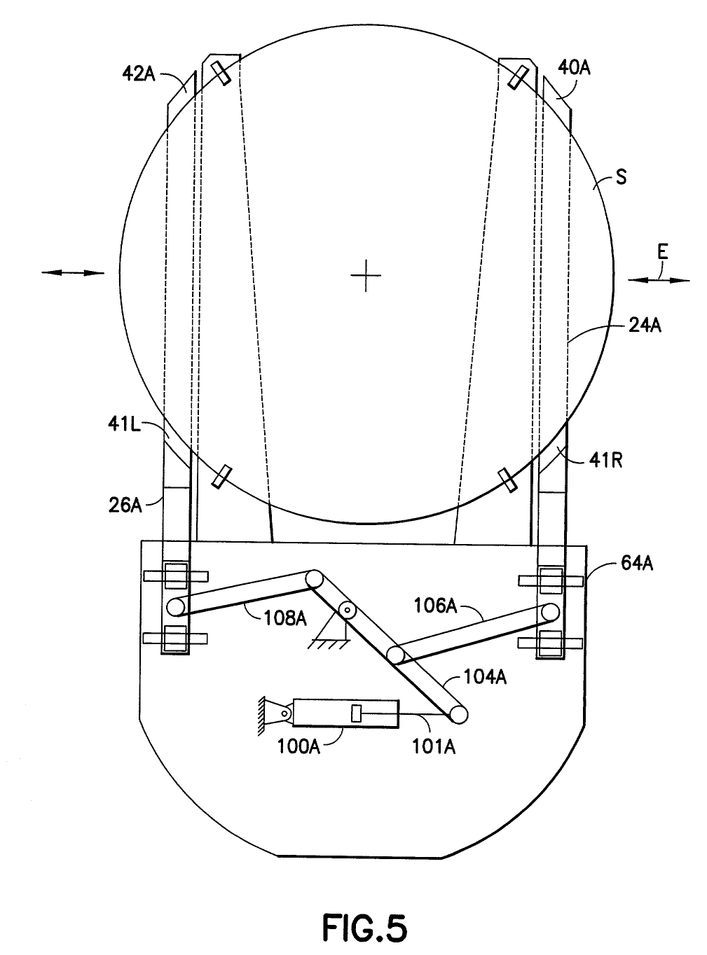

In alternate embodiments, a double side grip end effector may be provided which has any suitable number of gripping tines and gripping members for holding the edge of the substrate on the end effector. In other alternate embodiments, the actuating mechanism for moving the gripping tines laterally may be of any other suitable type. One such mechanism is shown for example in FIG. 5. As can be realized, the end effector 64A in this embodiment is generally similar to the end effector 64 described above and shown in FIGS. 2-4. Similar features are thus similarly numbered. In this embodiment however, the actuator 100A is mounted in a transverse configuration with the actuator shaft 101A aligned transverse to the centerline CA of the end effector. Accordingly, the gripping section 16A of this end effector does not have a center gripping member, and instead has a pair of opposing gripping members 40A, 41R, and 42A, 41L on each gripping tine 24A, 26A. Gripping members 40A, 42A are substantially the same as members 40, 42 described before. Gripping member 41R, 41L may be configured generally as mirror images to the gripping members 40A, 42A as can be seen in FIG. 5. In this embodiment, the linkage 102A connecting the actuator 100A to the gripping tines 24A, 26A has a central crank member 104A which is pivotally mounted to the end effector and pivotally linked at one end to the actuator 100A as seen in FIG. 5. Links 106A, 108A connect the crank 104A to the opposing gripping tines 24A, 26A. The gripping tines may each have a socket mounting the tine on one or more linear bearings or rails in a manner similar to that described before for gripping tines 24, 26 shown in FIG. 2. In alternate embodiments, the opposing gripping tines of the gripping section may be mounted to the end effector in any other suitable manner that allows the gripping tines to move freely in a transverse direction. As shown in FIG. 5, the actuator is capable of moving the opposing gripping tines 24A, 26A in opposing directions as indicated by arrow E in FIG. 5 in order to open and close the gripping members 40A, 41R, 42A, 41L around the edge of the substrate S.

The present invention provides an end effector substrate gripping system which can actively hold a substrate on the end effector with no backside contact while moving at high accelerations used for high throughput applications. The edge grip end effector of the present invention reduces the number of defects added to the back side of a substrate when compared to a vacuum grip end effector. The gripping end effector of the present invention will also center the substrate which simplifies the functionality of wafer aligners to simplify locating and positioning of various characteristic features of the substrate (e.g. wafer notch in the case of semi-conductor wafers). The four tine configuration of the present end effector also allows all of the bearing and support mechanisms to be located near or at the wrist and away from the immediate proximity of the substrate S on the end effector. Thus, any rubbing parts that may create particles are not in close proximity of the substrate S. In addition, the edge grip end effector of the present invention can place and pick substrates with neutral throughput impact relative to vacuum grip effectors, because it does not employ the extra motion of conventional edge gripping end effectors.

It should be understood that the foregoing description is only illustrative of the invention. Various alternatives and modifications can be devised by those skilled in the art without departing from the invention. Accordingly, the present invention is intended to embrace all such alternatives, modifications and variances which fall within the scope of the appended claims.

What is claimed is:

1. A substrate transport apparatus comprising:
a drive section;
an articulated arm connected to the drive section, the articulated arm having an end effector for transporting a substrate; and
a gripper connected to the end effector for holding the substrate on the end effector, the gripper having at least two actuated contact pads for gripping the substrate, the at least two actuated contact pads being disposed on the end effector so that when actuated the at least two contact pads are translated inwards relative to the end effector to grip the substrate and position a center of the substrate to a predetermined location on the end effector irrespective of a dimensional variance of the substrate.

2. The apparatus according to claim 1, wherein the gripper has three or more actuated contact pads.

3. The apparatus according to claim 1, wherein the at least two pads are located on opposite sides of the end effector.

4. The apparatus according to claim 3, wherein the gripper has a third actuated contact pad, the third pad being located on the end effector with respect to the at least two pads so that when actuated the third pad cooperates with the at least two pads to center the substrate on the end effector.

5. The apparatus according to claim 1, wherein the gripper has at least two movable arms extending on opposite sides of the end effector, and has an actuator operably connected to the at least two arms for moving the arms in a direction towards a center of the end effector.

6. The apparatus according to claim 5, wherein each of the at least two pads is located on a corresponding arm of the at least two arms.

7. The apparatus according to claim 6, wherein the end effector has a proximal end where the end effector is joined to a supporting member of the articulated arm, the at least two movable arms being movably mounted to the end effector at the proximal end, and the at least two pads being located on the at least two arms at a distal end of the end effector.

8. The apparatus according to claim 1, wherein the at least two contact pads are positioned so that when actuated to grip the substrate, at least one of the at least two pads contacts a peripheral edge of the substrate.

9. The apparatus according to claim 1, further comprising a sensor for sensing a feature of the substrate.

10. The apparatus according to claim 9, wherein the sensor is adapted to detect a surface of the substrate, and an edge of the surface.

11. The apparatus according to claim 9, wherein the sensor is an optical sensor.

12. The apparatus according to claim 1, wherein when actuated the at least two contact pads grip the substrate and position the center of the substrate to the predetermined location substantially at the same time.

13. A substrate transport apparatus comprising:
a drive section;
an articulated arm connected to the drive section for transporting a substrate, the articulated arm having an end effector for holding the substrate, the end effector having a substrate support section with support pads for supporting the substrate, the support pads projecting from a surface of the support section so that when the substrate is seated on the end effector, the support pads support the substrate elevated from the surface of the support section; and
a gripper mounted on the end effector for securing the substrate to the end effector, the gripper having contact pads disposed on the end effector for gripping a peripheral edge of the substrate and stably holding the substrate in the gripper;
wherein all contact pads of the gripper are actuated to move relative to the end effector between a first position and a second position.

14. The apparatus according to claim 13, wherein when the contact pads are in the first position, the gripper is open and when the contact pads are in the second position the gripper is closed.

15. The apparatus according to claim 13, wherein the contact pads are disposed so that when actuated to the second position, the contact pads cause the substrate to become centered with respect to the end effector.

16. The apparatus according to claim 13, wherein the gripper has arms that are movably connected to the end effector and extend along the end effector on opposite sides of the end effector, and wherein the gripper includes an actuator operably connected to the arms to move the arms in and out relative to a center of the end effector.

17. The apparatus according to claim 16, wherein each arm has at least one of the contact pads mounted thereon.

18. The apparatus according to claim 16, wherein the actuator has a powered drive member which moves in a reciprocating manner and is connected to the arms to effect movement of the arms.

19. The apparatus according to claim 18, wherein at least one of the contact pads is mounted on the drive member.

20. The apparatus according to claim 13 further comprising an optical sensor for sensing the peripheral edge of the substrate.

21. In a substrate transport apparatus having an articulated arm with an end effector for holding a substrate and a gripper on the end effector for capturing the substrate to the end effector, wherein the improvement comprises:
the gripper having a pair of movable arms extending on opposite sides of the end effector for gripping the substrate, each arm being movably connected to the end effector to move relative to the end effector, and the gripper having an actuator connected to the movable arms for moving the arms in opposite directions relative to each other between open positions and closed positions.

22. The apparatus according to claim 21, wherein the movable arms have contact pads, and wherein in the closed position the contact pads are biased against a peripheral edge of the substrate, and in the open position at least one contact pad is spaced apart from the substrate.

23. The apparatus according to claim 21, wherein the actuator has a powered drive member that is connected to the arms to effect movement of the arms, and has a contact pad which is biased against the substrate when the arms are in the closed position.

24. A method for transporting a substrate with a substrate transport apparatus, the method comprising the steps of:
providing the substrate transport apparatus with an end effector for carrying the substrate, and a gripper for holding the substrate on the end effector, the gripper having actuated contact pads for gripping the substrate;
picking the substrate with the end effector;
actuating the contact pads so that the gripper closes and secures the substrate to the end effector substantially simultaneously with picking the substrate; and
moving the end effector to a predetermined position.

25. The method according to claim 24, wherein actuating the contact pads biases the substrate to a center of the end effector.

26. The method according to claim 24, wherein the contact pads grip a peripheral edge of the substrate.
